(19) United States
(12) Patent Application Publication
(10) Pub. No.: US 2016/0177060 A1
(43) Pub. Date: Jun. 23, 2016

(54) POLYAMIDE COMPOSITIONS

(71) Applicant: LANXESS Deutschland GmbH, Cologne (DE)

(72) Inventors: Jochen ENDTNER, Cologne (DE); Matthias BIENMUELLER, Krefeld (DE)

(21) Appl. No.: 14/966,609

(22) Filed: Dec. 11, 2015

(30) Foreign Application Priority Data
Dec. 19, 2014 (EP) 14199134.9

(51) Int. Cl. C08K 5/5313; C08K 5/053; C08K 7/14; C08K 3/32

(52) U.S. Cl. CPC C08K 5/5313; C08K 3/32; C08K 5/053; C08K 7/14

(57) ABSTRACT

The present invention relates to compositions based on nylon-6 and/or nylon-6,6, comprising at least one aluminium salt of phosphonic acid and at least one polyhydric alcohol.

The present invention relates to compositions based on nylon-6 and/or nylon-6,6, comprising at least one aluminium salt of phosphonic acid and at least one polyhydric alcohol.

### BACKGROUND OF THE INVENTION

Because of their good mechanical stability, their chemical stability and their good processibility, polyamides are an important thermoplastic material particularly in the sector of electrical and electronic components. However, there are specific applications in the electrical and electronics sector that very frequently make increased demands on flame retardancy, which is the reason why the polyamides used therein frequently have to be modified with flame retardants. Halogenated flame retardants are an option for the purpose but have recently been increasingly replaced for technical reasons, owing to public concerns, by halogen-free alternatives based, for example, on organic phosphorus compounds, for example metal phosphinates having organic substitution (EP 0 792 912 A2). The metal phosphinates having organic substitution are frequently used in combination with other flame retardant synergists based, for example, on nitrogen-containing flame retardants, or with further auxiliaries, for example metal borates, especially zinc borates (WO 2006/029711 A1).

With the advancing miniaturization of electronic components and the temperature rise associated with the increase in power density, however, questions relating to mechanical long-term stability at elevated sustained use temperatures are also becoming ever more pressing, especially since commonly used thermal stabilizers based on copper salts (U.S. Pat. No. 2,705,227) are frequently unusable in the electrical and electronics sector because of interactions of the salts with metallic contacts.

US 2013-0217814 A1 therefore discloses a polyimide composition comprising reinforcers and at least one halogen-free phosphorus-containing flame retardancy system based on metal phosphinates and a combination of boehmite and at least one polyhydric alcohol having more than two hydroxyl groups and an average molecular weight (Mn) of about 2000 or less for improving mechanical properties after thermal storage. Boehmite is used in US 2013-0217814 A1 as an alternative to melamine polyphosphate. However, a main disadvantage of these flame-retardant compositions according to US 2013-0217814 A1 is the adverse effect of the boehmite on the mechanical starting properties. A critical mention should also be made of the use of zinc borate mentioned in the examples, which should nowadays be avoided if possible because of its water hazard classification.

Additional information in connection with the present invention may be found in the following:

WO 2014/135256 A1, which discloses flame-retardant polyimide compositions based on a dialkylphosphinic salt and/or diphosphinic salt, a salt of phosphorous acid and a filler and reinforcer;

WO 2013/033287 A2, which describes thermoplastic compositions composed of polyamide and a polyhydric alcohol:

WO2012/140100 A1, which claims the use of a polyhydric alcohol having at least three hydroxyl groups for thermal stabilization and light stabilization of polyamides;

EP 1624015 A1, relating to flame-retardant polymer moulding compositions comprising nanoscale phosphorus-containing flame retardant based on at least one phosphinic salt and/or a diphosphinic salt;

DE 10 2004 019716 A1, disclosing flame retardant compositions comprising at least one salt of a phosphinic acid, of a diphosphinic acid and/or polymers thereof and at least one polyhydroxyl compound; and

J. B. Dahiya et. al., Polymer Degradation and Stability, Barking, GB, vol. 97, no. 8, 2012-05-18, pages 1458-1465, “The combined effect of organic phosphinate/ammonium polyphosphate and pentaerythritol on thermal and fire properties of polyamide 6-clay nanocomposites”.

The problem addressed by the present invention was therefore that of providing halogen-free flame-retardant polyamide compositions having elevated thermal stability, in which the systems for thermal stabilization have a minimum effect on the mechanical starting properties, are additionally free of copper halides and at the same time, if possible, do not require use of zinc borates either.

It has now been found that, surprisingly, compositions and products producible therefrom that are based on PA 6 or PA 66 and comprise at least one aluminium salt of phosphonic acid and at least one polyhydric alcohol in combination with organic metal phosphinates have a much improved thermal stability both at temperatures below the melting point of the composition and at temperatures above the melting point of the composition, without any adverse effect on flame retardancy in the UL94 test by the UL94V method or on the mechanical starting properties measured by the breaking stress to ISO527-1, -2 or the impact resistance measured according to Charpy (ISO179-1eU).

A measure of the thermal stability below the melting point is the percentage retention of breaking stress after hot air ageing for 45 days (1080 hours) at 200° C. In the case of 100% retention, the breaking stress after storage would then be identical to breaking stress on commencement of storage.

The assessment of thermal stability above the melting point is conducted by a test method based on the MVR test to ISO 1133-1 at a temperature of 270° C. and a load of 5 kg. A measure of thermal stability is considered to be the quotient of the MVR value after a residence time of 20 min and the MVR value after a residence time of 5 min. A quotient of 1 means that the melt viscosity after 20 min is unchanged compared to the value of 5 min. The higher the numerical value, the greater the decrease in melt viscosity and hence in the thermal degradation of the composition to be examined.

### SUMMARY OF THE INVENTION

The invention thus provides compositions and products producible therefrom, comprising
A) nylon-6 and/or nylon-6,6,
B) at least one aluminium salt of phosphonic acid,
C) at least one polyhydric alcohol having at least 3 alcohol groups and a molecular weight above 200 g/mol, and
D) one or more phosphinic salts of the formula (I) and/or one or more diphosphinic salts of the formula (II) and/or polymers thereof,

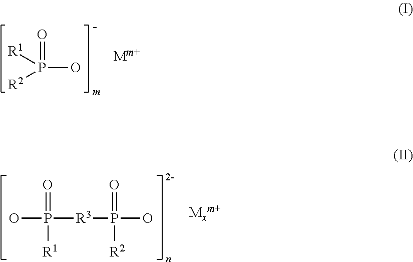

in which
R¹, R² are the same or different and are each a linear or branched C₁-C₆-alkyl, and/or C₆-C₁₄-aryl,
R³ is linear or branched C₁-C₁₀ alkylene, C₆-C₁₀ arylene or C₁-C₆ alkyl-C₆-C₁₀ arylene or C₆-C₁₀ aryl-C₁-C₆ alkylene,
M is aluminium, zinc or titanium,
m is an integer from 1 to 4,
n is an integer from 1 to 3,
x is 1 and 2,
where n, x and m in formula (II) may at the same time adopt only such integer values that the diphosphinic salt of the formula (II) as a whole is uncharged.

For clarity, it should be noted that the scope of the present invention encompasses all the definitions and parameters mentioned hereinafter in general terms or specified within areas of preference, in any desired combinations. Specified ranges with designated endpoints are encompassing of ranges from end point to end point, or from any value between the specified endpoints to any other value between the specified endpoints or to the endpoints. All standards in the context of the present description apply in the version valid at the filing date of this invention.

The inventive compositions are formulated for further utilization by mixing the components A) to D) for use as reactants in at least one mixing apparatus. This gives, as intermediates, moulding compositions based on the inventive compositions. These moulding compositions may either consist exclusively of components A) to D), or else contain further components in addition to components A) to D). In this case, components A) to D) should be varied within the scope of the ranges specified such that the sum total of all the percentages by weight is always 100.

### PREFERRED EMBODIMENTS OF THE INVENTION

Preferably, the present invention relates to compositions in which the proportion by mass of component B), based on the sum total of the proportions by mass of component B) and component D), is greater than 10%, preferably greater than 15%, more preferably greater than 20%. The proportion by mass is defined to DIN 1310.

In a preferred execution, the invention relates to compositions and products producible therefrom, comprising
A) about 25% to about 95% by weight, preferably 32% to 90% by weight, more preferably 35% to 85.5% by weight, of nylon-6 and/or nylon-6,6,
b) about 1% to about 15% by weight, preferably 3% to 10% by weight, more preferably 4% to 8% by weight, of at least one aluminium salt of phosphoric acid,
C) about a1% to about 5% by weight, preferably 0.3% to 3% by weight, more preferably 0.5% to 2% by weight, of at least one polyhydric alcohol having at least 3 alcohol groups and a molecular weight above 200 g/mol, and
D) about 3.9% to about 55% by weight, preferably 6.7% to 55% by weight, more preferably 10% to 55% by weight, of one or more organic phosphinic salts of the formula (I) and/or of one or more diphosphinic salts of the formula (II) and/or polymers thereof,

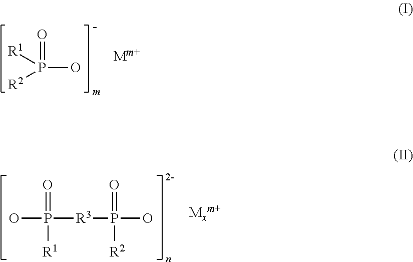

in which
R¹, R² are the same or different and are each a linear or branched C₁-C₆-alkyl, and/or C₆-C₁₄-aryl,
R³ is linear or branched C₁-C₁₀ alkylene, C₆-C₁₀ arylene or C₁-C₆ alkyl-C₆-C₁₀ arylene or C₆-C₁₀ aryl-C₁-C₆ alkylene,
M is aluminium, zinc or titanium,
m is an integer from 1 to 4,
n is an integer from 1 to 3, and
x is 1 and 2,

where n, x and m in formula (II) may at the same time adopt only such integer values that the diphosphinic salt of the formula (II) as a whole is uncharged, and with the proviso that the sum total of all the percentages by weight is always 100.

In a particularly preferred execution, the invention relates to compositions and products producible therefrom, comprising
A) about 25% to about 95% by weight, preferably about 32% to about 90% by weight, more preferably about 35% to about 85.5% by weight, of nylon-6 and/or nylon-6,6,
b) about 1% to about 15% by weight, preferably about 3% to about 10% by weight, more preferably about 4% to about 8% by weight, of at least one aluminium salt of phosphonic acid,
C) about 0.1% to about 5% by weight, preferably about 0.3% to about 3% by weight, more preferably about 0.5% to about 2% by weight, of at least one polyhydric alcohol having at least 3 alcohol groups and a mdecular weight above about 200 g/mol and below about 600 g/mol,
D) about 3.9% to about 55% by weight, preferably about 6.7% to about 55% by weight, more preferably about 10% to about 55% by weight, of one or more organic phosphinic salts of the formula (I) and/or of one or more diphosphinic salts of the formula (II) and/or polymers thereof,

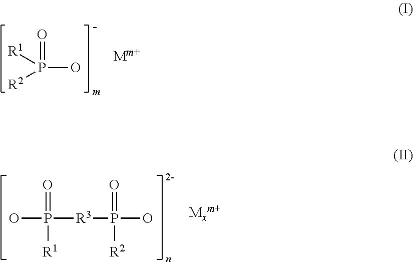

in which
R¹, R² are the same or different and are each a linear or branched C₁-C₆-alkyl, and/or C₆-C₁₄-aryl,
R³ is linear or branched C₁-C₁₀ alkylene, C₆-C₁₀ arylene or C₁-C₆ alkyl-C₆-C₁₀ arylene or C₆-C₁₀ aryl-C₁C₆ alkylene,
M is aluminium, zinc or titanium,
m is an integer from 1 to 4,
n is an integer from 1 to 3,
x is 1 and 2,

where n, x and m in formula (II) may at the same time adopt only such integer values that the diphosphinic salt of the formula (II) as a whole is uncharged, and with the proviso that the sum total of all the percentages by weight is always 100.

In a further particularly preferred execution, the invention relates to compositions and products producible therefrom, comprising
A) 25% to 95% by weight, preferably 32% to 90% by weight, more preferably 35% to 85.5% by weight, of nylon-6 and/or nylon-6,6,
b) 1% to 15% by weight, preferably 3% to 10% by weight, more preferably 4% to 8% by weight, of at least one aluminium salt of phosphonic acid,
C) 0.1% to 5% by weight, preferably 0.3% to 3% by weight, more preferably 0.5% to 2% by weight, of at least one polyhydric alcohol having at least 3 alcohol groups and a molecular weight above 200 g/mol and below 600 g/mol,
D) 3.9% to 55% by weight, preferably 6.7% to 55% by weight, more preferably 10% to 55% by weight, of one or more organic phosphinic salts of the formula (I) and/or of one or more diphosphinic salts of the formula (II) and/or polymers thereof,

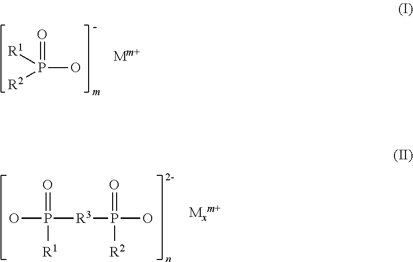

in which
R¹, R² are the same or different and are each a linear or branched C₁-C₆-alkyl, and/or C₆-C₁₄-aryl,
R³ is linear or branched C₁-C₁₀ alkylene, C₆-C₁₀ arylene or C₁-C₆ alkyl-C₆-C₁₀ arylene or C₆-C₁₀ aryl-C₁-C₆ alkylene,
M is aluminium, zinc or titanium,
m is an integer from 1 to 4,
n is an integer from 1 to 3,
x is 1 and 2,

where n, x and m in formula (II) may at the same time adopt only such integer values that the diphosphinic salt of the formula (II) as a whole is uncharged and with the proviso that the proportion by mass of component B), based on the sum total of the proportions by mass of component B) and component D), is greater than 10%, preferably greater than 15%, more preferably greater than 20% and that the sum total of all the percentages by weight of A), B), C) and D) is always 100.

In a preferred embodiment, the compositions comprise, in addition to components A), B), C), and D), also E) at least one thermal stabilizer from the group of the sterically hindered phenols, preferably to an extent of 0.01% to 3% by weight, more preferably to an extent of 0.1% to 2% by weight, most preferably to an extent of 0.3% to 1% by weight, based in each case on the overall composition, in which case the level of at least one of the other components is reduced to such an extent that the sum total of all the percentages by weight is always 100.

In a further preferred embodiment, the compositions comprise, in addition to components A) to E) or instead of E), also F) glass fibres, preferably to an extent of 5% to 60% by weight, more preferably to an extent of 10% to 50% by weight, most preferably to an extent of 15% to 45% by weight, based in each case on the overall composition, in which case the level of at least one of the other components is reduced to such an extent that the sum total of all the percentages by weight is always 100.

In a further preferred embodiment, the compositions comprise, in addition to components A) to F) or instead of E) and/or F), also G) at least one filler or reinforcer other than component E), preferably to an extent of 0.5% to 50% by weight, more preferably to an extent of 1% to 30% by weight, even more preferably to an extent of 2% to 15% by weight, especially preferably to an extent of 2% to 6% by weight, based in each case on the overall composition, in which case the level of at least one of the other components is reduced to such an extent that the sum total of all the percentages by weight is always 100.

In a further preferred embodiment, the compositions comprise, in addition to components A) to G) or instead of E) and/or F) and/or G), also H) at least one further additive other than components B) to E), preferably to an extent of 0.01% to 20% by weight, more preferably to an extent of 0.05% to 10% by weight, most preferably to an extent of 0.1% to 5% by weight, based in each case on the overall composition, in which case the level of at least one of the other components is reduced to such an extent that the sum total of all the percentages by weight is always 100.

As per the above, the following possible combinations of components A), B), C), D), E), F), G), and H) may be provided. For simplification, “X” will is used to represent combined components ABCD, such that possible combinations in addition to ABCD may include:
1 additional component: XE, XF, XG, XH;
2 additional components; XEG, XFG, XEF, XEH, XFH, XGH;
3 additional components: XEFG, XEGH, XFGH, XEFH; and
4 additional components: XEFGH.

In an alternative embodiment, the invention relates to compositions and products producible about is multiplied by 100%, it can also be reported in the form of a percentage; for this purpose, in the context of the present invention, per cent by weight (% by weight) is used.

Component A)

As component A), the compositions comprise PA 6 [CAS No. 25036-54-4] or PA 66 [CAS No. 32131-17-2]. Copolyamides based on PA 6 and/or PA 66 are encompassed by the subject-matter of the present invention.

The nomenclature of the polyamides used in the context of the present application corresponds to the international standard, the first number(s) indicating the number of carbon atoms in the starting diamine and the last number(s) the number of carbon atoms in the dicarboxylic acid. If only one number is stated, as in the case of PA6, this means that the starting material was an α,ω-aminocarboxylic acid or the lactam derived therefrom, i.e. ε-caprolactam in the case of PA 6; for further information, reference is made to H. Domininghaus, Die Kunststoffe und ihre Eigenschaften [The Polymers and Their Properties], pages 272 ff., VDI-Verlag, 1976.

Preferably, the nylon-6 or the nylon-6,6 for use as component A) has a viscosity number determined in a 0.5% by weight solution in 96% by weight sulphuric acid at 25° C. to ISO 307 in the range from 60 to 180 ml/g.

More preferably, the nylon-6 for use as component A), by the standard specified and by the method specified above, has a viscosity number in the range from 85 to 160 ml/g, most preferably a viscosity number in the range from 90 to 140 ml/g.

The nylon-6,6 for use as component A), by the method specified above, more preferably has a viscosity number in the range from 100 to 170 ml/g, most preferably a viscosity number in the range from 110 to 160 ml/g.

Viscosity measurements in solution are used to determine the K value, a molecular parameter by which the flow properties of polymers can be characterized. In simplified form: [η]=2.303×(75 k²+k) with K value=1000 k and [η]=Staudinger viscosity. The viscosity number J in cm³/g can be determined therefrom to DIN 53726 without complicated conversion.

$$J = ( \frac{η}{{η}_{0}} - 1 ) \cdot \frac{1}{c}$$

See: http://www.mhaeberl.de/KUT/3Kunststoffschmelze.htm. In practice, there exist conversion tables of K value to viscosity number J.

In accordance with Hans Domininghaus in “Die Kunststoffe and ihre Eigenschaften”, 5th edition (1998), p. 14, thermoplastic polyamides are understood to mean polyamides wherein the molecule chains do not have any side branches or else have side branches which are of greater or lesser length and differ in terms of number, and which soften when heated and are formable to a virtually unlimited degree.

The polyamides preferred in accordance with the invention can be prepared by various processes and synthesized from very different units and, in the specific application case, can be modified alone or in combination with processing auxiliaries, stabilizers or else polymeric alloy partners, preferably elastomers, to give materials having specific combinations of properties. Also suitable are blends having proportions of different polymers, preferably of polyethylene, polypropylene, acrylonitrile-butadiene-styrene copolymer (ABS), in which case it is optionally possible to use one or more compatibilizers. The properties of the polyamides can be improved through addition of elastomers, for example in terms of impact resistance. The multitude of possible combinations enables a very large number of products having a wide variety of different properties.

A multitude of known procedures for preparation of polyamides have become known, with use, depending on the desired end product, of different monomer units, different chain transfer agents to establish a desired molecular weight, or else monomers with reactive groups for aftertreatments intended at a later stage.

The processes of industrial relevance for preparation of the polyamides usually proceed via polycondensation in the melt. In the context of the present invention, the hydrolytic polymerization of lactams is also regarded as polycondensation.

The polyamides PA 6 and PA 66 for use as component A) are semicrystalline polyamides. Semicrystalline polyamides have, according to DE 10 2011 084 519 A1, an enthalpy of fusion in the range from 4 to 25 J/g, measured by the DSC method to ISO 11357 in the 2nd heating operation and integration of the melt peak. In contrast, amorphous polyamides have an enthalpy of fusion of less than 4 J/g, measured by the DSC method to ISO 11357 in the 2nd heating operation and integration of the melt peak.

The nylon-6 for use as component A) is obtainable from ε-caprolactam. The nylon-6,6 for use as component A) is obtainable from hexamethylenediamine and adipic acid.

Preference is further given to most of the compounds based on PA 6, PA 66 or copolyamides thereof, in which there are 3 to 11 methylene groups, very especially preferably 4 to 6 methylene groups, for each polyamide group in the polymer chain.

Nylon-6 is obtainable, for example, as Durethane® B26 from Lanxess Deutschland GmbH, Cologne, and nylon-6,6 as Ultramide® A27E from BASF SE, Ludwigshafen.

Component B)

As component B), the compositions comprise at least one aluminium salt of phosphonic acid.

According to Wikipedia, phosphonic acid is understood to mean the substance having the empirical formula H₃PO₃ [CAS No. 13598-36-2] (http://de.wikipedia.org/wiki/Phosphons%C3%A4ure). The salts of phosphonic acid are called phosphonates. Phosphonic acid may exist in two tautomeric forms, one of them having a free electron pair on the phosphorus atom and the other a double-bonded oxygen to the phosphorus (P═O). The tautomeric equilibrium is entirely on the side of the form with the double-bonded oxygen. According to A. F. Holleman, E. Wiberg: Lehrbuch der Anorganischen Chemie [Inorganic Chemistry], 101st edition, Walter de Gruyter, Berlin/New York 1995, ISBN 3-11-012641-9, p. 764, the terms “phosphorous acid” and “phosphites” should be used only for the tautomeric species having a free electron pair on the phosphorus. However, the terms “phosphorous acid” and “phosphites” were also formerly used for the tautomeric forms having oxygen double-bonded to the phosphorus, and so, in the present invention, the terms “phosphoric acid” and “phosphorous acid” and the terms “phosphonates” and “phosphites” are used synonymously with one another.

Preference is given to using, as component B), at least one aluminium salt of phosphoric acid selected from the group of

primary aluminium phosphonate [Al(H₂PO₃)₃],

basic aluminium phosphonate [Al(OH)H₂PO₃)₂.2H₂O],

Al₂(HPO₃)₂.x Al₂O₃.n H₂O

with x in the range of 2.27 to 1 and n in the range of 0 to 4,

Al₂(HPO₃)₃.(H₂O)_{q} (III)

with q in the range from 0 to 4, especially aluminium phosphonate tetrahydrate [Al₂(HPO₃)₃.4H₂O] or secondary aluminium phosphonate [Al₂(HPO₃)₃],

Al₂M_{z}(HPO₃)_{y}(OH)ᵥ.(H₂O)_{w} (IV)

in which M denotes alkali metal ion(s) and z is in the range of 0.01 to 1.5, y in the range of 2.63-3.5, v in the range of 0 to 2 and w in the range of 0 to 4, and

Al₂(HPO₃)ᵤ(H₂PO₃)ₜ.(H₂O)ₛ (V)

in which u is in the range of 2 to 2.99, t in the range of 2 to 0.01 and s in the range of 0 to 4,

where z, y and v in formula (IV) and u and t in formula (V) may only assume such values that the corresponding aluminium salt of the phosphonic acid as a whole is uncharged.

Preferred alkali metals in formula (IV) are sodium and potassium.

The aluminium salts of phosphonic acid described may be used individually or in a mixture.

Particularly preferred aluminium salts of phosphonic acid are selected from the group of

primary aluminium phosphonate [Al(H₂PO₃)₃],

secondary aluminium phosphonate [Al₂(HPO₃)₃],

basic aluminium phosphonate [Al(OH)H₂PO₃)₂.2H₂O],

aluminium phosphonate tetrahydrate [Al₂(HPO₃)₃.4H₂O] and

Al₂(HPO₃)₃.x Al₂O₃.n H₂O

with x in the range of 2.27 to 1 and n in the range of 0 to 4,

Very particular preference is given to secondary aluminium phosphonate [Al₂(HPO₃)₃, CAS No. 71449-76-8] and secondary aluminium phosphonate tetrahydrate [Al₂(HPO₃)₃.4H₂O, CAS No. 156024-71-4], especially preference to secondary aluminium phosphonate [Al₂(HPO₃)₃].

The preparation of the aluminium salts of phosphonic acid for use as component B) in accordance with the invention is described, for example, in WO 2013/083247 A1. They are typically prepared by reacting an aluminium source, preferably aluminium isopropoxide, aluminium nitrate, aluminium chloride or aluminium hydroxide, with a phosphorus source, preferably phosphonic acid, ammonium phosphonate, alkali metal phosphonate, and optionally with a template, in a solvent at 20 to 200° C. over a time span of up to 4 days. For this purpose, aluminium source and phosphorus source are mixed, heated under hydrothermal conditions or at reflux, filtered off, washed and dried.

Preferred templates are hexane-1,6-diamine, guanidine carbonate or ammonia.

A preferred solvent is water.

Component C)

As component C), the compositions comprise at least one polyhydric alcohol having at least 3 alcohol groups and a molecular weight above 200 g/mol, “Alcohol group” refers to a chemical structure in which an oxygen atom is joined to a carbon atom and a hydrogen atom. Preferably, the molecular weight of component C) is in the range of above 200 g/mol and below 600 g/mol. Preferred polyhydric alcohols for use in accordance with the invention as component C) belong to the group of the aliphatic polyhydric alcohols, the aliphatic-cycloaliphatic polyhydric alcohols or the cycloaliphatic polyhydric alcohols, and the carbohydrates.

An aliphatic chain in the polyhydric alcohol may contain not just carbon atoms but also heteroatoms selected from the group of nitrogen, sulphur and oxygen. A cycloaliphatic structural element as part of the polyhydric alcohol may be monocyclic or part of a bicyclic or polycyclic ring system. The ring structure may be composed exclusively of carbon atoms or else be heterocyclic. A heterocyclic ring as part of the polyhydric alcohol may be monocyclic or part of the bicyclic or polycyclic ring system and may contain one or more heteroatoms, preferably from the group of nitrogen, oxygen and sulphur. The polyhydric alcohol may also contain at least one further substituent such as ether, carboxyl, ester or amide groups.

Preference is given to those polyhydric alcohols in which at least one pair of alcohols is in such a relationship that the carbon atoms joined to each of the alcohols are separated from one another by at least one atom. Particular preference is given to those polyhydric alcohols in which at least one pair of alcohols is in such a relationship that the carbon atoms joined to each of the alcohols are separated from one another by one carbon atom.

Very particularly preferred polyhydric alcohols are selected from the group of dipentaerythritol [CAS No. 126-58-9] and tripentaerythritol [CAS No. 78-24-0], especial preference being given to dipentaerythritol.

Component D)

As component D), the compositions comprise one or more organic phosphinic salts of the above-specified formula (I) and/or one or more diphosphinic salts of the above-specified formula (II) and/or polymers thereof. Phosphinic salts and diphosphinic salts are also referred to in the context of the present invention as phosphinates.

In the formulae (I) or (II), M is preferably aluminium. In the formulae (I) and (II), R¹ and R² are preferably identical or different and are C₁-C₆ alkyl, near or branched, and/or phenyl. More preferably, R¹ and R² are identical or different and are methyl, ethyl, n-propyl, isopropyl, n-butyl, tert-butyl, n-pentyl and/or phenyl.

Preferably, R³ in formula (II) is methylene, ethylene, n-propylene, isopropylene, n-butylene, tert-butylene, n-pentylene, n-octylene, n-dodecylene, phenylene, naphthylene, methylphenylene, ethylphenylene, tert-butylphenylene, methylthaphthylene, ethylnaphthylene, tert-butylnaphthylene, phenylmethylene, phenylethylene, phenylpropylene or phenylbutylene. More preferably, R³ is phenylene or naphthylene. Suitable phosphinates are described in WO-A 97/39053, the content of which in relation to the phosphinates is encompassed by the present application. Particularly preferred phosphinates in the sense of the present invention are aluminium salts and zinc salts of dimethylphosphinate, of ethylmethylphosphinate, of diethylphosphinate and of methyl-n-propylphosphinate and also mixtures thereof.

In formula (I), m is preferably 2 and 3, more preferably 3.

In formula (II), n is preferably 1 and 3, more preferably 3.

In formula (II), x is preferably 1 and 2, more preferably 2.

Very particular preference is given to using, as component D), aluminium tris(diethylphosphinate) [CAS No. 225789-38-8], which is supplied, for example, by Clariant International Ltd. Muttenz, Switzerland under the Exolit® OP1230 or Exolit® OP1240 trade name.

Component E)

As components E), the compositions may comprise at least one thermal stabilizer selected from the group of the sterically hindered phenols.

These compounds have a phenolic structure having at least one sterically demanding group on the phenolic ring. Preferred sterically hindered phenols are compounds having one molecular unit of the formula (VI)

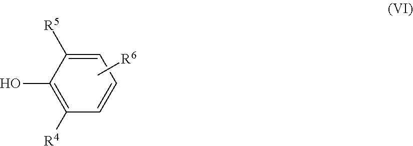

in which R⁴ and R⁵ are each an alkyl group, a substituted alkyl group or a substituted triazole group, where the R⁴ and R⁵ radicals may be the same or different, and R⁶ is an alkyl group, a substituted alkyl group, an alkoxy group or a substituted amino group.

In organic chemistry, steric hindrance describes the influence of the spatial extent of a molecule on the progress of the reaction. The term describes the fact that some reactions proceed only very slowly, if at all, when large and bulky groups are present in the vicinity of the reacting atoms. One well-known example of the influence of steric hindrance is the reaction of ketones in a Grignard reaction. If di-tert-butyl ketone is used in the Grignard reaction, the very bulky tert-butyl groups retard the reaction to such an extent that no more than a methyl group may be introduced; even larger radicals do not react at all.

Very particularly preferred thermal stabilizers of the formula (VI) are described as antioxidants, for example, in DE-A 27 02 661 (U.S. Pat. No. 4,360,617), the content of which is encompassed in full by the present application. A further group of preferred sterically hindered phenols derives from substituted benzenecarboxylic acids, especially from substituted benzenepropionic acids. Particularly preferred compounds from this class are compounds of the formula (VII)

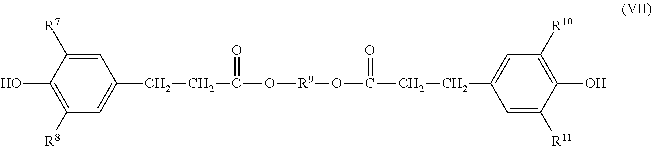

in which R⁷, R⁸, R¹⁰ and R¹¹ are each independently C₁-C₈-alkyl groups which may themselves be substituted (at least one of these is a sterically demanding group) and R⁹ is a divalent aliphatic radical which has 1 to 10 carbon atoms and may also have C—O bonds in the main chain. Preferred compounds of the formula (VII) are compounds of the formulae (VIII), (IX) and (X).

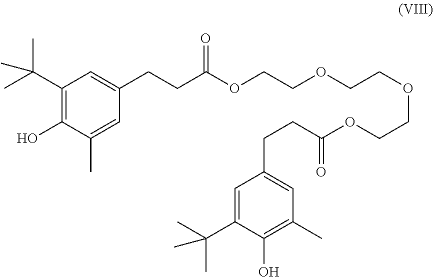 [SMILES: Cc1cc(CCC(=O)OCCOCCOCCOC(=O)CCc2cc(C)c(O)c(C(C)(C)C)c2)cc(C(C)(C)C)c1O]

Formula (VIII) is Irganox® 245 from BASF SE [CAS No. 36443-68-2], which has the chemical name triethylene glycol bis(3-tert-butyl-4-hydroxy-5-methylphenyl)propionate.

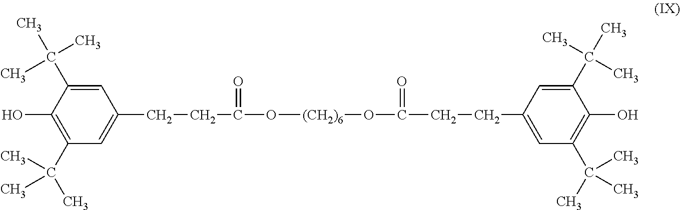

Formula (IX) is Irganox® 259 from BASF SE [CAS No. 35074-77-2], which has the chemical name 1,6-hexamethylene bis(3,5-di-(tert)-butyl-4-hydroxyhydrocinnamate.

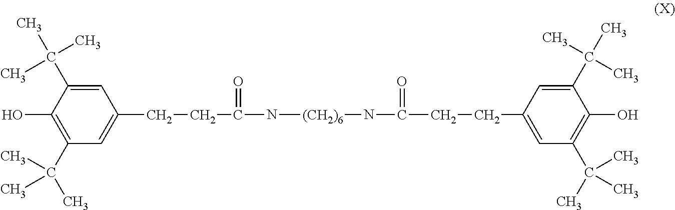

Formula (X) is Irganox® 1098 from BASF SE [CAS No. 23128-74-7], which has the chemical name N,N′-hexamethylenebis[3-(3,5-di-t-butyl-4-hydroxyphenyl)propionamide].

Thermal stabilizers for use with very particular preference as component E) are selected from the group of 2,2′-methylenebis(4-methyl-6-tert-butylphenol), 1,6-hexanediyl bis[3-(3,5-di-tert-butyl-4-hydroxyphenyl)propionate], pentaerythrityl tetrakis[3-(3,5-di-tert-butyl-4-hydroxyphenyl)propionate], distearyl 3,5-di-tert-butyl-4-hydroxybenzylphosphonate, 2,6,7-trioxa-1-phosphabicyclo[2.2.2]oct-4-ylmethyl 3,5-di-tert-butyl-4-hydroxyhydrocinnamate, 3,5-di-tert-butyl-4-hydroxyphenyl-3,5-distearylthiotriazylamine, 2-(2′-hydroxy-3′-hydroxy-3′,5′-di-tert-butylphenyl)-5-chlorobenzotriazole, 2,6-di-tert-butyl-4-hydroxymethylphenol, 1,3,5-trimethyl-2,4,6-tris(3,5-di-tert-butyl-4-hydroxybenzyl)benzene, 4,4′-methylenebis(2,6-di-tert-butylphenol), 3,5-di-tert-butyl-4-hydroxybenzyldimethylamine.

Thermal stabilizers for use with especial preference as component E) from the group of the sterically hindered phenols are 2,2′-methylenebis(4-methyl-6-tert-butylphenol), 1,6-hexanediyl bis[3-(3,5-di-tert-butyl-4-hydroxyphenyl)propionate] (Irganox® 259), pentaerythrityl tetrakis[3-(3,5-di-tert-butyl-4-hydroxyphenyl)propionate] and N,N′-hexamethylenebis-3,5-di-tert-butyl-4-hydroxyhydrocinnamide (Irganox® 1098), and the above-described Irganox® 245 from BASF SE, Ludwigshafen, Germany.

A thermal stabilizer very especially preferred in accordance with the invention from the group of the sterically hindered phenols is N,N′-hexamethylenebis-3,5-di-tert-butyl-4-hydroxyhydrocinnamide [CAS No. 23128-74-7], available as Irganox® 1098 from BASF SE, Ludwigshafen, Germany or as Lowinox® HD 98 from Weihai Jinwei ChemIndustry Co., Ltd., among other suppliers.

Component F)

As component F), the compositions may comprise glass fibres.

According to “http://de.wikipedia.org/wiki/Faser-Kunststoff-Verbund”, a distinction is made between chopped fibres, also called short fibres, having a length in the range from 0.1 to 1 mm, long fibres, having a length in the range from 1 to 50 mm, and continuous fibres, having a length L>50 mm. Short fibres are used in injection moulding technology and can be processed directly with an extruder. Long fibres can likewise still be processed in extruders. They are widely used in spray lay-up. Long fibres are frequently added to thermosets as a filler. Continuous fibres are used in the form of rovings or fabric in fibre-reinforced plastics.

Products comprising continuous fibres achieve the highest stiffness and strength values. Further available are ground glass fibres, the length of these after grinding typically being in the range from 70 to 200 μm.

Preference is given in accordance with the invention to using, as component F), chopped long glass fibres having an initial length in the range from 1 to 50 mm, more preferably in the range from 1 to 10 mm and very preferably in the range from 2 to 7 mm.

Glass fibres for use with preference as component F) have a fibre diameter in the range from 7 to 18 μm, more preferably in the range from 9 to 15 μm. The glass fibres of component F), in a preferred embodiment, are modified with a suitable size system or an adhesion promoter or adhesion promoter system. Preference is given to using a silane-based size system or adhesion promoter.

Particularly preferred silane-based adhesion promoters for the treatment of the glass fibres for use as component F) are sane compounds of the general formula (XI)

(X—(CH₂)_{q})ₖ—Si—(O—CrH₂ᵣ₊₁)₄₋ₖ (XI)

in which

X is NH₂—, carboxyl-, HO— or

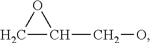

q in formula (XI) is an integer from 2 to 10, preferably 3 to 4,

r in formula (XI) is an integer from 1 to 5, preferably 1 to 2, and

k in formula (XI) is an integer from 1 to 3, preferably 1.

Especially preferred adhesion promoters are shine compounds from the group of aminopropyltrimethoxysilane, aminobutyltrimethoxysilane, aminopropyltriethoxysilane, aminobutyltriethoxysilane, and the corresponding silanes containing a glycidyl group or a carboxyl group as the X substituent, very especial preference being given to carboxyl groups.

For the modification of the glass fibres for use as component F), the adhesion promoters, preferably the silane compounds of formula (XI), are used preferably in amounts of 0.05% to 2% by weight, more preferably in amounts of 0.25% to 1.5% by weight and most preferably in amounts of 0.5% to 1% by weight, based in each case on 100% by weight of component F).

The glass fibres of component F), as a result of the processing to give the composition or to give the product, may be shorter in the composition, or in the product, than the glass fibres originally used. Thus, the arithmetic mean of the glass fibre length after processing is frequently only in the range from 150 μm to 300 μm.

According to “http://www.r-g.de/wiki/Glasfasern”, glass fibres are produced in a melt spinning process (die drawing, rod drawing and die blowing processes). In the die drawing process, the hot mass of glass flows under gravity through hundreds of die bores in a platinum spinneret plate. The filaments can be drawn at a speed of 3-4 km/minute with unlimited length.

The person skilled in the art distinguishes between different types of glass fibres, some of which are listed here by way of example:
E glass, the most commonly used material having an optimal cost-benefit ratio (E glass from R&G)
H glass, hollow glass fibres for reduced weight (R&G hollow glass fibre fabric 160 g/m² and 216 g/m²)
R, S glass, for high mechanical demands (S2 glass from R&G)
D glass, borosilicate glass for high electrical demands
C glass, with increased chemical durability
quartz glass, with high thermal stability

Further examples can be found under “http://de.wikipedia.org/wiki/Glasfaser”. E glass fibres have gained the greatest significance for reinforcement of plastics. E stands for electro-glass, since it was originally used in the electrical industry in particular.

For the production of E glass, glass melts are produced from pure quartz with additions of limestone, kaolin and boric acid. As well as silicon dioxide, they contain different amounts of various metal oxides. The composition determines the properties of the products. Preference is given in accordance with the invention to using at least one type of glass fibres from the group of E glass, H glass, R, S glass, D glass, C glass and quartz glass, particular preference to using glass fibres made of E glass.

Glass fibres made of E glass are the most commonly used reinforcing material. The strength properties correspond to those of metals (for example aluminium alloys), the specific weight of laminates containing E glass fibres being lower than that of the metals. E glass fibres are non-combustible, heat-resistant up to about 400° C. and resistant to most chemicals and weathering influences.

Component G)

As component G), the compositions may comprise at least one further filler or reinforcer other than components E).

In this case, it is also possible to use mixtures of two or more different filler and/or reinforcers, preferably based on talc, mica, silicate, amorphous quartz glass, quartz flour, wollastonite, kaolin, amorphous silicas, nanoscale minerals, more preferably montmorillonites, magnesium carbonate, chalk, feldspar, barium sulphate and/or fibrous fillers and/or reinforcers based on carbon fibres, but also untreated surface-modified or sized spherical fillers and reinforcers made from glass, in an alternative embodiment, it is also possible—if required—to use nano-boehmite as component G). Preference is given to using mineral particulate fillers based on talc, mica, silicate, wollastonite, kaolin, amorphous silicas, magnesium carbonate, chalk, feldspar and/or barium sulphate. Particular preference is given to using mineral particulate fillers based on talc, wollastonite and/or kaolin.

Particular preference is additionally also given to using acicular mineral fillers. Acicular mineral fillers are understood in accordance with the invention to mean a mineral filler with a highly pronounced acicular character. Preference is given to acicular wollastonites. The acicular mineral filler preferably has a length:diameter ratio in the range from 2:1 to 35:1, more preferably in the range from 3:1 to 19:1, especially preferably in the range from 4:1 to 12:1. The median particle size of the acicular mineral fillers is preferably less than 20 μm, more preferably less than 15 μm, especially preferably less than 10 μm, determined with a CILAS GRANULOMETER.

Particular preference is also given to using non-fibrous and non-foamed ground glass having a particle size distribution having a d90 in the range from 5 to 250 μm, preferably in the range from 10 to 150 μm, more preferably in the range from 15 to 80 μm, most preferably in the range from 16 to 25 μm, and a length in the range from 0.01 to 0.5 mm. Preference is given to using non-fibrous and non-foamed ground glass additionally having a d10 in the range from 0.3 to 10 μm, preferably in the range from 0.5 to 6 μm, more preferably in the range from 0.7 to 3 μm. Very particular preference is given to such non-fibrous and non-foamed ground glass as also has a d50 in the range from 3 to 50 μm, preferably in the range from 4 to 40 μm, more preferably in the range from 5 to 30 μm.

With regard to the d10, d50 and d90 values, the determination thereof and the meaning thereof, reference is also made to Chemie Ingenieur Technik (72) p. 273-276, 3/2000, Wiley-VCH Verlags GmbH, Weinheim, 2000, according to which the d10 is that particle size below which 10% of the amount of particles lie, the d50 is that particle size below which 50% of the amount of particles lie (median value) and the d90 is that particle size below which 90% of the amount of particles lie.

Preferably, a non-fibrous and non-foamed ground glass for use in accordance with the invention has a median particle size in the range from 3 to 60 μm, especially preferably in the range from 15 to 30 μm. The figures for the particle size distribution and for the particle sizes are based here on so-called surface-based particle sizes, in each case prior to incorporation into the thermoplastic moulding composition. In this context, the diameters of the surfaces of the respective glass particles are expressed in relation to the surfaces of imaginary spherical particles (spheres). This is accomplished with a particle size analyser that works by the principle of laser dimming from Ankersmid (Eye Tech® including the EyeTech® software and ACM-104 measurement cell, Ankersmid Lab, Oosterhout, the Netherlands). But it is also possible to employ laser diffractometry, as already elucidated above, according to standard ISO 13320 for particle size determination.

Preferably in accordance with the invention, the non-fibrous and non-foamed ground glass is in particulate, non-cylindrical form and has a length to thickness ratio of less than 5, preferably less than 3, more preferably less than 2. The value of zero is of course impossible.

The non-foamed and non-fibrous ground glass for use with particular preference as component G) is additionally characterized in that it does not have the glass geometry typical of fibrous glass with a cylindrical or oval cross section having an aspect ratio (length/diameter ratio) greater than 5.

The non-foamed and non-fibrous ground glass for use with particular preference as component G) in accordance with the invention is preferably obtained by grinding glass with a mill, preferably a ball mill and more preferably with subsequent sifting or screening. Useful starting materials include all geometric forms of solidified glass.

Preferred starting materials for the grinding to give non-fibrous and non-foamed ground glass for use in accordance with the invention are also glass wastes as obtained especially in the production of glass products as unwanted by-product and/or as off-spec main product. These especially include waste glass, recycled glass and broken glass as can be obtained especially in the production of window or bottle glass, and in the production of glass-containing fillers and reinforcers, especially in the form of what are called melt cakes. The glass may be coloured, although preference is given to non-coloured glass as starting material.

Useful starting glasses for the grinding in principle include all glass types as described, for example, in DIN 1259-1. Preference is given to soda-lime glass, float glass, quartz glass, lead crystal glass, borosilicate glass, A glass and E glass, particular preference being given to soda-lime glass, borosilicate glass, A glass and E glass, very particular preference to A glass and E glass, especially E glass. For the physical data and composition of E glass, reference may be made to “http://wiki.r-g.de/index.php?title=Glasfasern”. Non-fibrous and non-foamed ground E glass for use with especial preference in accordance with the invention has at least one of the following features specified in Table I:

TABLE I

| Properties of E glass | Unit | E glass |
|---|---|---|
| Density | g/cm² at 20° C. | 2.6 |
| Tensile strength | MPa | 3400 |
| Tensile modulus of elasticity | GPa | 73 |
| Elongation at break | % | 3.5-4 |

| Chemical composition | Unit | Value |
|---|---|---|
| SiO₂ | % | 53-55 |
| Al₂O₃ | % | 14-15 |
| B₂O₃ | % | 6-8 |
| CaO | % | 17-22 |
| MgO | % | <5 |
| K₂O, Na₂O | % | <1 |
| Other oxides | % | about 1 |

For the production of the non-foamed and non-fibrous glass for use as component G) in accordance with the invention, particular preference is likewise given to glass types in which the K₂O content is less than or equal to 2% by weight, based on all the components of the glass. The non-foamed and non-fibrous ground glass for use as component G) in accordance with the invention can be purchased, for example, from VitroMinerals, Covington, Ga., USA. It is supplied as CS Glass Powder in the specifications CS-325, CS-500 and CS-600, or else as LA400 (see also “www.glassfillers.com” or Chris DeArmitt, Additives Feature, Mineral Fillers, COMPOUNDING WORLD, February 2011, pages 28-38 or “www.compoundingworld.com”).

The non-foamed and non-fibrous ground glass for use as a component G) in a preferred embodiment preferably has a density (not bulk densityl) to ASTM C 693 in the range from 2400 to 2700 kg/m³, more preferably in the range from 2400 to 2600 kg/m³, and is therefore distinctly different from foamed glass (density=100-165 kg/m³), foamed glass pellets (density=130-170 kg/m³) and expanded glass (density=110-360 kg/m³); see also AGY product brochure Pub. No. LIT-2006-111 R2 (02/06).

Preferably in accordance with the invention, the non-foamed and non-fibrous ground glass for use as component G) is provided with surface modification or sizing based on aminoalkyltrialkoxysilane. In alternative or preferred embodiments, the non-foamed and non-fibrous ground glass may be provided with additional surface modification or sizing based on silane or siloxane, preferably with glycidyl-, carboxyl-, alkenyl-, acryloyloxyalkyl- and/or methacryloyloxyalkyl-functionalized trialkoxysilanes or aqueous hydrolysates thereof, and combinations thereof.

Preferred aminoalkyltrialkoxysilanes are aminopropyltrimethoxysilane, aminobutyltrimethoxysilane, aminopropyltriethoxysilane, aminobutyltriethoxysilane or aqueous hydrolysates thereof, very particular preference being given to aminopropyltriethoxysilane.

The aminoalkyltrialkoxysilanes are preferably used for surface coating in amounts of 0.01% by weight to 1.5% by weight, more preferably in amounts of 0.05% by weight to 1.0% by weight and most preferably in amounts of 0.1% by weight to 0.5% by weight, based on the non-foamed and non-fibrous ground glass.

The starting glass for the grinding may already have been given surface modification or sizing treatment. It is likewise possible for the non-foamed and non-fibrous ground glass for use as component G) in accordance with the invention to be given surface modification or sizing treatment after the grinding.

It is especially possible to use MF7900 from Lanxess Deutschland GmbH, Cologne, a non-fibrous and non-foamed ground glass based on E glass having a d90 of 54 μm, a d50 of 14 μm, a d10 of 2 μm, and having a median particle size of 21 μm, based in each case on the particle surface area, and containing about 0.1% by weight of triethoxy(3-aminopropyl)silane size.

The non-foamed and non-fibrous ground glass for use as component G) in accordance with the invention may, as a result of the processing to give the inventive composition or to give products producible therefrom and in the products themselves, have a smaller d90 or d50 or d10 or a smaller median particle size than the ground particles originally used.

Apart from the non-foamed and non-fibrous ground glass, the other fillers and/or reinforcers mentioned as component G), in a preferred embodiment, have also been surface-modified, preferably with an adhesion promoter or adhesion promoter system, more preferably with an adhesion promoter system based on silane. However, the pretreatment is not absolutely necessary. Useful adhesion promoters likewise include the silane compounds of the general formula (XI) already described above.

For the modification of component G), the silane compounds are generally used for surface coating in amounts of 0.05% to 2% by weight, preferably in amounts of 0.25% to 1.5% by weight and especially in amounts of 0.5% to 1% by weight, based on the mineral filler of component G).

These further fillers mentioned for component G) may also, as a result of the processing to give the composition or to give the product from the composition, or in the product, have a smaller d97 or d50 than the fillers originally used.

Component H)

As component H), at least one further additive other than components B) to E) is used.

Additives for use with preference as component H) are antioxidants and thermal stabilizers, UV stabilizers, gamma ray stabilizers, hydrolysis stabilizers, antistats, emulsifiers, nucleating agents, plasticizers, processing aids, impact modifiers, dyes, pigments, laser absorbers, lubricants and/or demoulding agents other than component E), and further flame retardants, flow auxiliaries and elastomer modifiers other than component B) and E). The additives can be used alone or in a mixture, or in the form of masterbatches.

Preferred thermal stabilizers for component H) are phosphites, hydroquinones, aromatic secondary amines such as diphenylamines, substituted resorcinols, salicylates, benzotriazoles and benzophenones, and also variously substituted representatives of these groups or mixtures thereof.

In an alternative embodiment, it is also possible to use, as component H)—if required—copper salts, especially copper(I) iodide, preferably in combination with potassium iodide, and/or sodium hypophosphite NaH₂PO₂.

UV stabilizers used are preferably substituted resorcinols, salicylates, benzotriazoles and benzophenones.

Colourants used are preferably inorganic pigments, especially ultramarine blue, iron oxide, titanium dioxide, zinc sulphide or carbon black, and also organic pigments, preferably phthalocyanines, quinacridones, perylenes, and dyes, preferably nigrosin and anthraquinones.

Nucleating agents used are preferably sodium phenylphosphinate or calcium phenylphosphinate, aluminium oxide or silicon dioxide, and most preferably talc, this enumeration being non-exclusive.

Flow auxiliaries used are preferably copolymers of at least one α-olefin with at least one methacrylic ester or acrylic ester of an aliphatic alcohol. Particular preference is given to copolymers in which the α-olefin is formed from ethene and/or propene and the methacrylic ester or acrylic ester contains, as alcohol component, linear or branched alkyl groups having 6 to 20 carbon atoms. Very particular preference is given to 2-ethylhexyl acrylate. Features of the copolymers suitable as flow assistants are not just their composition but also their low molecular weight. Accordingly, suitable copolymers for the compositions that are to be protected from thermal degradation in accordance with the invention are particularly those which have an MFI value measured at 196° C. and a load of 2.16 kg of at least 100 g/10 min, preferably of at least 150 g/10 min, more preferably of at least 300 g/10 min. The MFI, melt flow index, is used to characterize the flow of a melt of a thermoplastic and is governed by the standards ISO 1133 or ASTM D 1238.

Plasticizers for use with preference as component H) are dioctyl phthalate, dibenzyl phthalate, butyl benzyl phthalate, hydrocarbon oils or N-(n-butyl)benzenesulphonamide.

The elastomer modifiers for use as component H) preferably include one or more graft polymers of
H.1 5% to 95% by weight, preferably 30% to 90% by weight, of at least one vinyl monomer and
H.2 95% to 5% by weight, preferably 70% to 10% by weight, of one or more graft bases having glass transition temperatures of <10° C., preferably <0° C., more preferably <−20° C.

The graft base H.2 generally has a median particle size (d50) of 0.05 to 10 μm, preferably 0.1 to 5 μm, more preferably 0.2 to 1 μm.

Monomers for H.1 are preferably mixtures of
H.1.1 50% to 99% by weight of vinylaromatics and/or ring-substituted vinylaromatics, especially styrene, α-methylstyrene, p-methylstyrene, p-chlorostyrene, and/or (C₁-C₈)-alkyl methacrylates, especially methyl methacrylate, ethyl methacrylate, and
H.1.2 1% to 50% by weight of vinyl cyanides, especially unsaturated nitriles such as acrylonitrile and methacrylonitrile, and/or (C₁-C₈)-alkyl(meth)acrylates, especially methyl methacrylate, glycidyl methacrylate, n-butyl acrylate, t-butyl acrylate, and/or derivatives, especially anhydrides and imides, of unsaturated carboxylic acids, especially maleic anhydride and N-phenylmaleimide.

Preferred monomers H.1.1 are selected from at least one of the monomers styrene, α-methylstyrene and methyl methacrylate; preferred monomers H.1.2 are selected from at least one of the monomers acrylonitrile, maleic anhydride, glycidyl methacrylate and methyl methacrylate.

Particularly preferred monomers are H.1.1 styrene and H.1.2 acrylonitrile.

Examples of graft bases H.2 suitable for the graft polymers for use in the elastomer modifiers are diene rubbers, EPDM rubbers, i.e. those based on ethylene/propylene and optionally diene, and also acrylate, polyurethane, silicone, chloroprene and ethylene/vinyl acetate rubbers. EPDM stands for ethylene-propylene-diene rubber.

Preferred graft bases H.2 are diene rubbers, especially based on butadiene, isoprene, etc., or mixtures of diene rubbers or copolymers of diene rubbers or mixtures thereof with further copolymerizable monomers, especially as per H.1.1 and H.1.2, with the proviso that the glass transition temperature of component H.2 is <10° C., preferably <0° C., more preferably <−10° C.

Particularly preferred graft bases H.2 are ABS polymers (emulsion, bulk and suspension ABS), where ABS stands for acrylonitrile-butadiene-styrene, as described, for example, in DE-A 2 035 390 (=U.S. Pat. No. 3,644,574) or in DE-A 2 248 242 (=GB -A 1 409 275) or in Ullmann, Enzyklopädie der Technischen Chemie [Encyclopedia of Industrial Chemistry], vol. 19 (1980), p. 280 ff. The gel content of the graft base H.2 is preferably at least 30% by weight, more preferably at least 40% by weight (measured in toluene).

The elastomer modifiers or graft polymers are prepared by free-radical polymerization, preferably by emulsion, suspension, solution or bulk polymerization, especially by emulsion or bulk polymerization.

Particularly suitable graft rubbers are also ABS polymers prepared by redox initiation with an initiator system composed of organic hydroperoxide and ascorbic add in accordance with U.S. Pat. No. 4,937,235.

Since, as is well known, the graft monomers are not necessarily grafted completely onto the graft base in the grafting reaction, according to the invention, graft polymers are also understood to mean those products which are obtained through (co)polymerization of the graft monomers in the presence of the graft base and occur in the workup as well.

Likewise suitable acrylate rubbers are based on graft bases H.2, which are preferably polymers of alkyl acrylates, optionally with up to 40% by weight, based on H.2, of other polymerizable, ethylenically unsaturated monomers. The preferred polymerizable acrylic esters include C₁-C₈-alkyl esters, preferably methyl, ethyl, butyl, n-octyl and 2-ethylhexyl esters; haloalkyl esters, preferably halo-C₁-C₈-alkyl esters, such as chloroethyl acrylate, glycidyl esters and mixtures of these monomers. Particular preference is given here to graft polymers having butyl acrylate as core and methyl methacrylate as shell, especially Paraloid® EXL2300, from Dow Corning Corporation, Midland Mich., USA.

For crosslinking, it is possible to copolymerize monomers having more than one polymerizable double bond. Preferred examples of crosslinking monomers are esters of unsaturated monocarboxylic adds having 3 to 8 carbon atoms and unsaturated monohydric alcohols having 3 to 12 carbon atoms or of saturated polyols having 2 to 4 OH groups and 2 to 20 carbon atoms, preferably ethylene glycol dimethacrylate, allyl methacrylate; polyunsaturated heterocyclic compounds, preferably trivinyl cyanurate and triallyl cyanurate; polyfunctional vinyl compounds, preferably di- and trivinylbenzenes; but also triallyl phosphate and diallyl phthalate.

Preferred crosslinking monomers are allyl methacrylate, ethylene glycol dimethacrylate, diallyl phthalate and heterocyclic compounds having at least 3 ethylenically unsaturated groups.

Particularly preferred crosslinking monomers are the cyclic monomers triallyl cyanurate, triallyl isocyanurate, triacryloylhexahydro-s-triazine, triallylbenzenes. The amount of the crosslinked monomers is preferably 0.02% to 5% by weight, especially 0.05% to 2% by weight, based on the graft base H.2.

In the case of cyclic crosslinking monomers having at least 3 ethylenically unsaturated groups, it is advantageous to restrict the amount to below 1% by weight of the graft base H.2.

Preferred “other” polymerizable, ethylenically unsaturated monomers, which in addition to the acrylic esters may optionally serve for the preparation of the graft base H.2, are acrylonitrile, styrene, α-methylstyrene, acrylamides, vinyl C₁-C₆ alkyl ethers, methyl methacrylate, glycidyl methacrylate and butadiene. Preferred acrylate rubbers as graft base H.2 are emulsion polymers having a gel content of at least 60 wt %.

Further preferentially suitable graft bases according to H.2 are silicone rubbers having graft-active sites, as described in DE-A 3 704 657 (=U.S. Pat. No. 4,859,740), DE-A 3 704 655 (=U.S. Pat. No. 4,861,831), DE-A 3 631 540 (=U.S. Pat. No. 4,808,593) and DE-A 3 631 539 (=U.S. Pat. No. 4,812,515).

As well as elastomer modifiers based on graft polymers, it is likewise possible to use elastomer modifiers which are not based on graft polymers and have glass transition temperatures of <10° C., preferably <0° C., more preferably <−20° C. These preferably include elastomers having a block copolymer structure, and additionally thermoplastically meltable elastomers, especially EPM, EPDM and/or SEBS rubbers (ERA=ethylene-propylene copolymer, EPDM=ethylene-propylene-diene rubber and SEBS=styrene-ethene-butene-styrene copolymer).

Preferred further flame retardants are mineral flame retardants, nitrogen-containing flame retardants or phosphorus-containing flame retardants other than components B) and E).

Preferred nitrogen containing flame retardants are the reaction products of trichlorotriazine, piperazine and morpholine according to CAS No. 1078142-02-5, especially MCA PPM Triazine HF from MCA Technologies GmbH, Biel-Benken, Switzerland, melamine cyanurate and condensation products of melamine, for example melem, melam, melon or more highly condensed compounds of this type. Preferred inorganic nitrogen-containing compounds are ammonium salts.

In addition, it is also possible to use salts of aliphatic and aromatic sulphonic acids and mineral flame retardant additives such as aluminium hydroxide and/or magnesium hydroxide, Ca—Mg carbonate hydrates (e.g. DE-A 4 236 122).

Also useful are flame retardant synergists from the group of the oxygen-, nitrogen- or sulphur-containing metal compounds, particular preference being given to zinc-free compounds for the reasons mentioned above, especially molybdenum oxide, magnesium oxide, magnesium carbonate, calcium carbonate, calcium oxide, titanium nitride, boron nitride, magnesium nitride, calcium phosphate, calcium borate, magnesium borate or mixtures thereof.

In an alternative embodiment, it is also possible to use zinc compounds as component H)—if required, taking account of the above-described disadvantages. These preferably include zinc oxide, zinc borate, zinc stannate, zinc hydroxystannate, zinc sulphide and zinc nitride, or mixtures thereof.

In an alternative embodiment, it is also possible to use halogenated flame retardants as component H)—if required, taking account of the associated disadvantages.

Preferred halogen-containing flame retardants are standard organic halogen compounds, more preferably ethylene-1,2-bistetrabromophthalimide, decabromodiphenylethane, tetrabromobisphenol A epoxy oligomer, tetrabromobisphenol A oligocarbonate, tetrachlorobisphenol A oligocarbonate, polypentabromobenzyl acrylate, brominated polystyrene or brominated polyphenylene ethers, which can be used alone or in combination with synergists, especially antimony trioxide or antimony pentoxide.

Preferred phosphorus-containing flame retardants other than component B) or E) are red phosphorus, inorganic metal hypophosphites, especially aluminium hypophosphite, metal phosphonates, especially calcium phosphonate, derivatives of 9,10-dihydro-9-oxa-10-phosphaphenanthrene 10-oxides (DOPO derivatives), resorcinol bis(diphenyl phosphate) (RDP), including oligomers, and bisphenol A bis(diphenyl phosphate) (BDP) including oligomers, and also melamine pyrophosphate and, if required, melamine polyphosphate, and also melamine poly(aluminium phosphate), melamine poly(zinc phosphate) or phenoxyphosphazene oligomers and mixtures thereof.

Further flame retardants for use as component H) are char formers, more preferably phenol-formaldehyde resins, polycarbonates, polyimides, polysulphones, polyether sulphones or polyether ketones, and anti-dripping agents, especially tetrafluoroethylene polymers.

The flame retardants can be added in pure form, or else via masterbatches or compactates.

Lubricants and/or demoulding agents for use as component H) are preferably long-chain fatty adds, especially stearic acid or behenic add, salts thereof, especially calcium stearate or zinc stearate, and the ester derivatives or amide derivatives thereof, especially ethylenebisstearylamide, mortar waxes and low molecular weight polyethylene or polypropylene waxes.

Montan waxes in the context of the present invention are mixtures of straight-chain saturated carboxylic acids having chain lengths of 28 to 32 carbon atoms.

According to the invention, particular preference is given to using lubricants and/or demoulding agents from the group of the esters or amides of saturated or unsaturated aliphatic carboxylic acids having 8 to 40 carbon atoms with aliphatic saturated alcohols or amines having 2 to 40 carbon atoms, and metal salts of saturated or unsaturated aliphatic carboxylic acids having 8 to 40 carbon atoms.

Very particular preference is given to using at least one lubricant and/or demoulding agent from the group of ethylenebisstearylamide, calcium stearate and ethylene glycol dimontanate.

Especial preference is given to using calcium stearate [CAS No. 1592-23-0] or ethylenebisstearylamide [CAS No. 110-30-5].

Very especial preference is given to using ethylenebisstearylamide (Loxiol® EBS from Emery Oleochemicals).

Laser absorbers for use with preference as component H) are preferably selected from the group of antimony trioxide, tin oxide, tin orthophosphate, barium titanate, aluminium oxide, copper hydroxyphosphate, copper orthophosphate, potassium copper diphosphate, copper hydroxide, antimony tin oxide, bismuth trioxide and anthraquinone. Particular preference is given to antimony trioxide and antimony tin oxide. Very particular preference is given to antimony trioxide.

The laser absorber, especially antimony trioxide, can be used directly as a powder or in the form of masterbatches. Preferred masterbatches are those based on polyimide or those based on polybutylene terephthalate, polyethylene, polypropylene, polyethylene-polypropylene copolymer, maleic anhydride-grafted polyethylene and/or maleic anhydride-grafted polypropylene, it being possible to use the polymers for the antimony trioxide masterbatch individually or in a mixture. Very particular preference is given to using antimony trioxide in the form of a nylon-6-based masterbatch.

The laser absorber can be used individually or as a mixture of a plurality of laser absorbers.

Laser absorbers can absorb laser light of a particular wavelength. In practice, this wavelength is in the range from 157 nm to 10.6 μm. Examples of lasers of this wavelength are described in WO2009/003076 A1. Preference is given to using Nd:YAG lasers, with which it is possible to achieve wavelengths of 1064, 532, 355 and 266 nm, and CO₂ lasers.

In a preferred execution, the present invention relates to compositions comprising
A) nylon-6 and/or nylon-6,6,
B) at least one aluminium phosphonate of the formula (III) Al₂(HPO₃)₃.(H₂O)_{q} with q in the range from 0 to 4,
C) dipentaerythritol and
D) aluminium tris(diethylphosphinate).

In a preferred execution, the present invention relates to compositions comprising
A) nylon-6 and nylon-6,6,
B) at least one aluminium phosphonate of the formula (III) Al₂(HPO₃)₃.(H₂O)_{q} with q the range from 0 to 4,
C) dipentaerythritol and
D) aluminium tris(diethylphosphinate).

In a preferred execution, the present invention relates to compositions comprising
A) nylon-6 and/or nylon-6,6,
B) at least one aluminium phosphonate of the formula (III) Al₂(HPO₃)₃.(H₂O)_{q} with q in the range from 0 to 4,
C) dipentaerythritol,
D) aluminium tris(diethylphosphinate) and
E) at least one thermal stabilizer from the group of 2,2′-methylenebis-(4-methyl-6-tert-butylphenol), hexane-1,6-diol bis(3,5-di-tert-butyl-4-hydroxyphenyl]propionate (Irganox® 259), pentaerythrityl tetrakis[3-(3,5-di-tert-butyl-4-hydroxyphenyl)propionate], N,N′-hexamethylenebis-3,5-di-tert-butyl-4-hydroxyhydrocinnamide (Irganox® 1098) and triethylene glycol bis(3-tert-butyl-4-hydroxy-5-methylphenyl)propionate (Irganox® 245).

In a preferred execution, the present invention relates to compositions comprising
A) nylon-6 and nylon-6,6,
B) at least one aluminium phosphonate of the formula (III) Al₂(HPO₃)₃.(H₂O)_{q} with q in the range from 0 to 4,
C) dipentaerythritol,
D) aluminium tris(diethylphosphinate) and
E) N,N′-hexamethylenebis-3,5-di-tert-butyl-4-hydroxyhydrocinnamide (Irganox® 1098).

Method

The present invention additionally relates to a method for improving the thermal stability of PA6 and/or PA66-based compositions and products producible therefrom, without adversely affecting—compared to corresponding compositions having thermal stability improved in accordance with the prior art—flame retardancy in the UL94 test by the UL94V method for the mechanical starting properties, measured by the breaking strength to ISO 527-1, -2 or measured by the Charpy impact resistance (ISO179-1eU), by using

at least one aluminium salt of phosphoric acid in combination with

at least one polyhydric alcohol having at least 3 alcohol groups and a molecular weight above 200 g/mol and

with one or more organic phosphinic salts of the formula (I) and/or one or more diphosphinic salts of the formula (II) and/or polymers thereof,

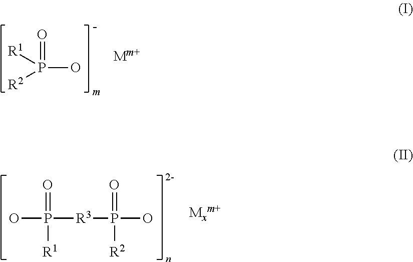

in which
R¹, R² are the same or different and are each a linear or branched C₁-C₆-alkyl, and/or C₆-C₁₄-aryl,
R³ is linear or branched C₁-C₁₀ alkylene, C₆-C₁₀ arylene or C₁-C₆ alkyl-C₆-C₁₀ arylene or C₆-C₁₀ aryl-C₁-C₆ alkylene,
M is aluminium, zinc or titanium,
m is an integer from 1 to 4,
n is an integer from 1 to 3,
x is 1 and 2,

where n, x and m in formula (II) may at the same time adopt only such integer values that the diphosphinic salt of the formula (II) as a whole is uncharged.

The present invention additionally relates to a process for producing products, preferably electrical components, more preferably residual current circuit breakers and other circuit breakers, most preferably circuit breakers having rated currents >16 A, especially preferably circuit breakers having rated currents >32 A, very especially preferably circuit breakers having rated currents >64 A, through use of the inventive compositions in injection moulding processes, including the special methods of GIT (gas injection technology), WIT (water injection technology) and PIT (projectile injection technology), in extrusion processes, including in profile extrusion, or in blow moulding processes.

For production of these products, the individual components of the inventive compositions are first mixed in at least one mixing tool and this mixture, which is then in the form of a moulding composition, is either fed through at least one mixing tool outlet directly to further processing or is discharged as a strand and cut into pellets of the desired length by means of a pelletizer, preferably a rotating bladed roller, in order to be available for a later processing operation.

Since most processors require plastic in the form of pellets, the pelletizing of the moulding compositions obtainable from the inventive compositions plays an essential role. A basic distinction is made between hot cutting and cold cutting. This results in different particle forms according to the processing. In the case of hot cutting, the pellets comprising the inventive compositions are obtained in beads or lenticular form; in the case of cold cutting, the pellets are obtained in cylinder forms or cube forms. Moulding compositions comprising inventive compositions in pellet form are preferably obtained by cold cutting.

The person skilled in the art is at liberty to use different mixing tools suitable for achieving an optimal mixing outcome in terms of mixing of the components in the moulding compositions obtainable from the inventive compositions. An extruder is a preferred mixing tool in the context of the present invention. Preferred extruders are single-screw extruders or twin-screw extruders and the respective sub-groups, most preferably conventional single-screw extruders, conveying single-screw extruders, contra-rotating twin-screw extruders or co-rotating twin-screw extruders. These are familiar to those skilled in the art from Technische Thermoplaste 4. Polyamide [Industrial Thermoplastics, 4. Polyamides], eds.: G. W. Becker and D. Braun, Cad Hanser Verlag, 1998, p. 311-314 and K. Brest, Thesis “Verarbeitung von Langfaser-verstärkten Thermoplasten im direkten Plastifizier-/Pressverfahren” [Processing of Long-Fibre Reinforced Thermoplastics Using the Direct Strand-Deposition Process], Rheinisch-Westfälische Technische Hochschule Aachen, 2001, p. 30-33.

The compositions present in the form of a moulding composition or pellets in accordance with the invention are ultimately used to produce the inventive products, preferably electrical or electronic products, by moulding methods. Preferred moulding methods are injection moulding or extrusion.

Inventive processes for producing products by extrusion or injection moulding work preferably at melt temperatures in the range from 230 to 330° C., more preferably at melt temperatures in the range from 250 to 300° C., and preferably additionally at pressures of not more than 2500 bar, more preferably at pressures of not more than 2000 bar, most preferably at pressures of not more than 1500 bar and especially preferably at pressures of not more than 750 bar.

The process of injection moulding features melting (plastification) of the inventive composition as a moulding composition, preferably in pellet form, in a heated cylindrical cavity, and injection thereof as an injection moulding material under pressure into a temperature-controlled cavity. After the cooling (solidification) of the material, the injection moulding is demoulded. This process is divided into the steps of
1. plastification/melting
2. injection phase (filling operation)
3. hold pressure phase (owing to thermal contraction in the course of crystallization)
4. demoulding.

An injection moulding machine consists of a closure unit, the injection unit, the drive and the control system. The closure unit includes fixed and movable platens for the mould, an end platen, and tie bars and drive for the movable mould platen (toggle joint or hydraulic closure unit).

An injection unit comprises the electrically heatable barrel, the drive for the screw (motor, gearbox) and the hydraulics for moving the screw and the injection unit. The task of the injection unit is to melt the composition for use in accordance with the invention as a moulding composition, especially in the form of pellets, to meter it, to inject it into at least one cavity and to maintain the hold pressure (owing to contraction). The problem of the melt flowing backward within the screw (leakage flow) is solved by non-return valves.

In the injection mould, the incoming melt is then separated and cooled, and hence the component to be produced is produced. Two halves of the mould are always needed for this purpose. In injection moulding, the following functional systems are distinguished:
runner system
shaping inserts
venting
machine casing and force absorber
demoulding system and movement transmission
heating

The special injection moulding methods of GIT (gas injection technology), WIT (water injection technology) and projectile injection technology (PIT) are specialized injection moulding methods for production of hollow workpieces. A difference from standard injection moulding is a specific working step towards the end of the mould filling phase or after a defined partial filling of the casting mould. In the method-specific working step, a process medium is injected through an injector into the molten core of the preform to form a cavity. This medium is gas—generally nitrogen—in the case of GIT, and water in the case of WIT. In the case of PIT, a projectile is propelled into the molten core and a cavity is formed in this way.

In contrast to injection moulding, extrusion uses a continuous shaped polymer strand, comprising the inventive composition, in an extruder, the extruder being a machine for producing shaped thermoplastics. The following devices are distinguished:
single-screw extruder and twin-screw extruder and the respective sub-groups,
conventional single-screw extruder, conveying single-screw extruder,
contra-rotating twin-screw extruder and co-rotating twin-screw extruder.

Profiles in the context of the present invention are components or parts having identical cross section over their entire length. They can be produced in a profile extrusion method. The basic method steps in the profile extrusion method are:
1. plasticizing and providing the thermoplastic melt in an extruder,
2. extruding the thermoplastic melt strand through a calibration sleeve having the cross section of the profile to be extruded,
3. cooling the extruded profile on a calibrating table,
4. transporting the profile onward using a draw system beyond the calibration table,
5. cutting the previously continuous profile to length in a cutting system,
6. collecting the profiles which have been cut to length on a collecting table.

A description of the profile extrusion of nylon-6 and nylon-6,6 is given in Kunststoff-Handbuch [Plastics Handbook] 3/4, Polyamide [Polyamides], Carl Hanser Verlag, Munich 1998, pages 374-384.

Blow moulding methods in the context of the present invention are preferably standard extrusion blow moulding, 3D extrusion blow moulding, suction blow moulding methods, and sequential coextrusion.

The basic method steps in standard extrusion blow moulding are, according to Thielen, Hartwig, Gust, “Blasformen von Kunststoffhohlkörpern” [Blow Moulding of Hollow Plastics Bodies], Carl Hanser Verlag, Munich, 2006, pages 15 to 17:
1. plasticizing and providing the thermoplastic melt in an extruder,
2. deflecting the melt in a vertical flowing movement in the downward direction and forming a tubular melt “parison”,
3. enclosing the suspended parison by means of a mould generally consisting of two half-shells, the blow mould,
4. inserting a blowing mandrel or one or more blowing pin(s),
5. blowing the plastic parison against the cooled wall of the blow mould, where the plastic cools and solidifies and takes on the ultimate form of the moulding,
6. opening the mould and demoulding the blow-moulded part,
7. removing the pinched-off “flash” wastes at either end of the blow moulding.

Further post-processing steps may follow.

By means of standard extrusion blow moulding, it is also possible to produce products having a complex geometry and multiaxial curvature. In that case, however, products which contain a large proportion of excess, pinched-off material and have a weld seam in large regions are obtained.

In 3D extrusion blow moulding, also referred to as 3D blow moulding, therefore, weld seams are avoided and material use is reduced by using specific devices to deform and manipulate a parison having a diameter matched to the article cross section, and then introducing it directly into the blow mould cavity. The remaining pinch seam is therefore reduced to a minimum at the ends of the article (Thielen, Hartwig, Gust, “Blasformen von Kunststoffhohlkörpern”, Carl Hanser Verlag, Munich 2006, pages 117-122).

In the suction blow moulding method, also referred to as suction blowing, the parison is conveyed directly out of the tubular die head into the closed blow mould and “sucked” through the blow mould by means of an air stream. After the lower end of the parison has emerged from the blow mould, it is pinched off at the top and bottom by means of closure elements, and this is followed by the blowing and cooling procedure (Thielen, Hartwig, Gust, “Blasformen von Kunststoffhohlkörpern”, Carl Hanser Verlag, Munich 2006, page 123).

Use

The present application also provides for the use of the inventive compositions as moulding compositions in injection moulding processes, including the special methods of GIT (gas injection technology), WIT (water injection technology) and PIT (projectile injection technology), in extrusion processes, including in profile extrusion, in blow moulding processes, more preferably standard extrusion blow moulding, 3D extrusion blow moulding methods or suction blow moulding methods, in order to produce inventive thermally stabilized products therefrom.

The present invention also relates to the use of the inventive compositions for production of products, but also composite structures and overmoulded composite structures, preferably of electrical components, more preferably of residual current circuit breakers and other circuit breakers, most preferably circuit breakers having rated currents >16 A, especially preferably circuit breakers having rated currents >32 A, very especially preferably circuit breakers having rated currents >64 A.

Inventive products can preferably be used in the automotive sector as components for passenger vehicles, heavy goods vehicles, commercial aircraft, in aerospace, in trains, in industrial systems, but also for garden and domestic appliances, as computer hardware, in handheld electronic devices, in leisure articles and sports equipment, as machine components, in buildings, in photovoltaic systems or in mechanical devices.

Preferred applications in the garden and household are, without restriction, washing machines, dishwashers, dryers, refrigerators, air conditioning systems, lawnmowers, heating, fuseboxes, alarm systems.

It will be understood that the specification and examples are illustrative but not limitative of the present invention and that other embodiments within the spirit and scope of the invention will suggest themselves to those skilled in the art.

### EXAMPLES

To demonstrate the improvements in properties described in accordance with the invention, corresponding polymer compositions were first made up by compounding. For this purpose, the individual components according to Table II were mixed in a twin-screw extruder (ZSK 25 Compounder from Coperion Werner & Pfleiderer (Stuttgart, Germany)) at temperatures between 270 and 300° C., discharged as a strand, cooled until pelletizable and pelletized. After drying (generally for two days at 80° C. in a vacuum drying cabinet), the pellets were processed at temperatures in the range from 270 to 290° C. to give standard test specimens for the respective tests.

The flame retardancy of the fibre-matrix semifinished products was determined according to method UL94V (Underwriters Laboratories Inc. Standard of Safety, “Test for Flammability of Plastic Materials for Parts in Devices and Appliances”, p. 14 to p. 18 Northbrook 1998). The dimensions of the test specimens were 126 mm·13 mm·0.75 mm.

Breaking stress was obtained from a tensile test based on ISO 527-1, -2 on dumbbell specimens according to ISO 3167, type A, and was measured or determined in each case on specimens in the freshly injection-moulded state.

Breaking stress after hot air ageing (“Breaking stress [aged]”) was determined by storing the tensile specimens at 200° C. in a Binder FP115 hot air oven from Binder, Tuttlingen, Germany for 45 d (1080 h), cooling them to room temperature and then testing them as described above.

The melt viscosity was determined on the pellets in accordance with ISO 1133-1 at a temperature of 270° C. with a load of 5 kg, by determining the values after a residence time of 5 min and of 20 min to determine the thermal stability of each composition. The quotient of the value after 20 min and the value after 5 min (“Quotient from MVR”) is considered, as described at the outset, to be a measure of the thermal stability of the composition at temperatures above the melting point. In the case of a quotient of 1, the melt viscosity is unchanged after 5 min and after 20 min, which suggests a high thermal stability. The further the quotient is above 1, the more unstable the composition under these conditions.

Impact resistance was obtained according to Charpy in accordance with ISO179-1eU on test specimens of dimensions 80 mm·10 mm·4 mm.

The following were used in the experiments:
Component A/1 nylon-6,6 (Ultramid® A27E from BASF, Ludwigshafen, Germany)
Component A/2: nylon-6 (Durethan® B26, from Lanxess Deutschland GmbH, Cologne, Germany)
Component B/1: secondary aluminium phosphonate prepared according to WO 2013/083247 A1, Example 2
Component C/1: Dipentaerythritol [CAS No. 126-58-9] (Di-Penta 93 from Perstorp Speciality Chemicals AB, Perstorp, Sweden)
Component D/1: aluminium tris(diethylphosphinate), [CAS No. 225789-38-8] (Exolit® OP1230 from Clariant SE, Muttenz, Switzerland)
Component E/1: Irganox 1098® thermal stabilizer, from BASF, Ludwigshafen, Germany
Component F/1: CS 7928 chopped glass fibres from Lanxess Deutschland GmbH, Cologne, Germany [median fibre diameter 11 μm, median fibre length 4.5 mm, E glass]
Component H/1: ethylenebisstearylamide [CAS No. 110-30-5] in the form of Loxiol® EBS from Emery Oleochemicals

TABLE II

| Component | | Ex. 1 | Comp. 1 |
|---|---|---|---|
| A/1 | [% by wt.] | 35.2 | 36.2 |
| A/2 | [% by wt.] | 15 | 15 |
| B/1 | [% by wt.] | 6 | 6 |
| C/1 | [% by wt.] | 1 | |
| D/1 | [% by wt.] | 12 | 12 |
| E/1 | [% by wt.] | 0.5 | 0.5 |
| F/1 | [% by wt.] | 30 | 30 |
| H/1 | [% by wt.] | 0.3 | 0.3 |
| UL94 | [Class] | V-0 | V-1 |
| Breaking stress | [MPa] | 138 | 129 |
| Breaking stress [aged] | [MPa] | 110 | 95 |
| Breaking stress: | [%] | 80 | 74 |
| retention after ageing | | | |
| Charpy impact resistance | [kJ/m²] | 59 | 57 |
| MVR 270° C./5 kg 5 min | [cm³/10 min] | 27.7 | 23.1 |
| MVR 270° C./5 kg 20 min | [cm³/10 min] | 31.5 | 34.6 |
| Quotient MVR 20 min/MVR | | 1.1 | 1.5 |
| 5 min | | | |

Figures for the components in % by weight are based on the overall moulding composition.

The inventive example in Table II shows that the inventive combination with component led to a distinct improvement in thermal stability, both in the case of storage at temperatures below the melting point of the polyamides used for several days and in the case of brief stress at temperatures above the melting point of the polyamides used. The addition of component C/1 in combination with component B/1 did not lead either to a decrease in mechanical starting properties, breaking stress here, or to a decrease in flame retardancy, where an improvement in flame retardancy was actually achieved with a UL94 V-0 classification in Ex. 1 compared to V-1 in Comp. 1. It should be emphasized her that it was even possible to achieve a UL94 V-0 classification without use of zinc borate with Inventive Example 1.

What is claimed is:

1. A composition comprising
A) at least one of nylon-6 and nylon-6,6,
B) at least one aluminium salt of phosphoric acid,
C) at least one polyhydric alcohol having at least 3 alcohol groups and a molecular weight above 200 g/mol, and
D) one or more organic phosphinic salts of the formula (I) and/or one or more diphosphinic salts of the formula (II) and/or polymers thereof, 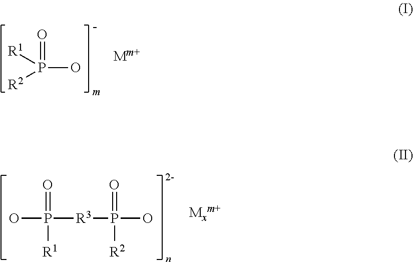
in which
R¹, R² are the same or different and are each a linear or branched C₁-C₆-alkyl, and/or C₆-C₁₄-aryl,
R³ is linear or branched C₁-C₁₀ alkylene, C₆-C₁₀ arylene or C₁-C₆ alkyl-C₆-C₁₀ arylene or C₆-C₁₀ aryl-C₁-C₆ alkylene,
M is aluminium, zinc or titanium,
m is an integer from 1 to 4,
n is an integer from 1 to 3,
x is 1 and 2,
where n, x and m in formula (II) may at the same time adopt only such integer values that the diphosphinic salt of the formula (II) as a whole is uncharged.

2. The composition according to claim 1, wherein the proportion by mass of component B), based on the sum total of the proportions by mass of component B) and component D), is greater than 10%.

3. The position according to claim 1, further comprising, in addition to components A) to D), also E) at least one thermal stabilizer from the group of sterically hindered phenols.

4. The position according to claim 1, further comprising, in addition to components A) to D), also F) glass fibres.

5. The composition according to claim 1, further comprising, in addition to components A) to D), also G) at least one filler or reinforcer.

6. The position according to claim 1, further comprising, in addition to components A) to D), combinations of any two of the following:
E) at least one thermal stabilizer from the group of sterically hindered phenols;
F) glass fibres; and
G) at least one filler or reinforce other than the component E).

7. The position according to claim 1, further comprising, in addition to components A) to D):
E) at least one thermal stabilizer from the group of sterically hindered phenols;
F) glass fibres; and
G) at least one filler or reinforce other than the component E).

8. The position according to claim 1, wherein component B) is at least one aluminium salt of phosphonic acid selected from the group of
primary aluminium phosphonate [Al(H₂PO₃)₃],
basic aluminium phosphonate [Al(OH)H₂PO₃)₂.2H₂O],
Al₂(HPO₃)₃.x Al₂O₃.n H₂O with x in the range from 2.27 to 1 and n in the range from 0 to 4,
Al₂(HPO₃)₃.(H₂O)_{q} (III)
with q in the range from 0 to 4,
Al₂M_{z}(HPO₃)_{y}(OH)ᵥ.(H₂O)_{w} (IV)
in which M denotes alkali metal ion(s) and z is in the range of 0.01 to 1.5, y in the range of 2.63-3.5, v in the range of 0 to 2 and w in the range of 0 to 4, and
Al₂(HPO₃)ᵤ(H₂PO₃)ₜ.(H₂O)ₛ (V)
in which u is in the range of 2 to 2.99, t in the range of 2 to 0.01 and s in the range of 0 to 4,
where z, y and v in formula (IV) and u and t in formula (V) may only assume such values that the corresponding aluminium salt of the phosphonic acid as a whole is uncharged.

9. The composition according to claim 1, wherein component B) is at least one aluminium salt of phosphonic acid selected from the group of
primary aluminium phosphonate [Al(H₂PO₃)₃],
secondary aluminium phosphonate [Al₂(HPO₃)₃],
basic aluminium phosphonate [Al(OH)H₂PO₃)₂.2H₂O],
aluminium phosphonate tetrahydrate [Al₂(HPO₃)₃.4H₂O], and
Al₂(HPO₃)₃.x Al₂O₃.n H₂O with x being 227 to 1 and n being 0 to 4.

10. The composition according to claim 1, wherein component C) comprises polyhydric alcohols, aliphatic polyhydric alcohols, aliphatic-cycloaliphatic polyhydric alcohols or cycloaliphatic polyhydric alcohols and carbohydrates.

11. The composition according to claim 1, wherein component C) is dipentaerythritol or tripentaerythritol.

12. The composition according to claim 1, wherein M in the formulae (I) or (II) is aluminium.

13. The composition according to claim 1, wherein R¹ and R² in the formulae (I) and (II) are the same or different and are each C₁-C₆ alkyl, linear or branched, and/or phenyl.

14. The composition according to claim 1, wherein R³ in formula (II) is methylene, ethylene, n-propylene, isopropylene, n-butylene, tert-butylene, n-pentylene, n-octylene, n-dodecylene, phenylene, naphthylene, methylphenylene, ethylphenylene, tert-butylphenylene, methylnaphthylene, ethylnaphthylene, tert-butylnaphthylene, phenylmethylene, phenylethylene, phenylpropylene or phenylbutylene.

15. The composition according to claim 1, wherein:
the proportion by mass of component B), based on the sum total of the proportions by mass of component B) and component D), is greater than 10%;
component B) is at least one aluminium salt of phosphonic acid selected from the group of:
primary aluminium phosphonate [Al(H₂PO₃)₃]
secondary aluminium phosphonate [Al₂(HPO₃)₃],
basic aluminium phosphonate [(Al(OH)H₂PO₃)₂.2H₂O],
aluminium phosphonate tetrahydrate [Al₂(HPO₃)₃.4H₂O], and
Al₂(HPO₃)₃.x Al₂O₃.n H₂O with x being 2.27 to 1 and n being 0 to 4;
component C) is dipentaerythritol or tripentaerythritol;
M in the formulae (I) or (II) is aluminium;
R¹ and R² in the formulae (I) and (II) are the same or different and are each C₁-C₆ alkyl, linear or branched, and/or phenyl; and
R³ in formula (II) is methylene, ethylene, n-propylene, isopropylene, n-butylene, tert-butylene, n-pentylene, n-octylene, n-dodecylene, phenylene, naphthylene, methylphenylene, ethylphenylene, tert-butylphenylene, methylnaphthylene, ethylnaphthylene, tert-butylnaphthylene, phenylmethylene, phenylethylene, phenylpropylene or phenylbutylene.

16. The composition according to claim 15, further comprising, in addition to components A) to D):
E) at least one thermal stabilizer from the group of sterically hindered phenols;
F) glass fibres;
G) at least one filler or reinforce other than the component E); and
H), at least one further additive other then components B) to E).

17. A method for improving the thermal stability of PA6- and/or PA66-based compositions and products produced therefrom, the method comprising combining the PA6 and/or the PA66 with:
at least one aluminium salt of phosphoric add;
at least one polyhydric alcohol having at least 3 alcohol groups and a molecular weight above 200 g/mol, and
one or more organic phosphinic salts of the formula (I) and/or one or more diphosphinic salts of the formula (II) and/or polymers thereof, 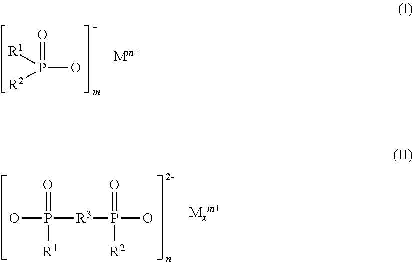
in which
R¹, R² are the same or different and are each a linear or branched C₁-C₆-alkyl, and/or C₆-C₁₄-aryl,
R³ is linear or branched C₁-C₁₀-alkylene, C₆-C₁₀-arylene or C₁-C₆-alkyl-C₆-C₁₀-arylene or C₆-C₁₀-aryl-C₁-C₆alkylene,
M is aluminium, zinc or titanium,
m is an integer from 1 to 4,
n is an integer from 1 to 3,
x is 1 and 2,
where n, x and m in formula (II) may at the same time adopt only such integer values that the diphosphinic salt of the formula (II) as a whole is uncharged.
to produce PA6 compositions and/or PA66 compositions.

18. The method according to claim 17, further comprising forming products from the PA6 compositions and/or PA66 compositions by at least one of injection moulding, gas injection molding, water injection molding, projectile injection molding, extrusion, profile extrusion, and blow-moulding.

19. The method according to claim 18, wherein the products are electrical components.
